(19) United States
(12) Patent Application Publication
(10) Pub. No.: US 2017/0096298 A1
(43) Pub. Date: Apr. 6, 2017

(54) Express Recycling Sack

(71) Applicant: Wal-Mart Stores, Inc., Bentonville, AR (US)

(72) Inventors: John Levy, Fayetteville, AR (US); Levi Jon Robinson, Centeron, AR (US)

(21) Appl. No.: 15/278,352

(22) Filed: Sep. 28, 2016

Related U.S. Application Data
(60) Provisional application No. 62/236,510, filed on Oct. 2, 2015.

(51) Int. Cl. B65F 1/14; B65F 1/16; B65F 1/00

(52) U.S. Cl. CPC B65F 1/1415; B65F 1/002; B65F 1/1452; B65F 1/16; B65F 2210/132; B65F 2220/1063

(57) ABSTRACT

An express recycling sack is provided. The recycling sack includes a collapsible frame and a flexible body attached to the frame. The recycling sack also includes a plurality of open drain apertures defined in the flexible body and a plurality of straps affixed to the flexible body. The recycling sack also includes a first flap having a toggle retained in and protruding perpendicularly therefrom and one or more additional flaps defining one or more flap apertures. The first flap and the one or more additional flaps are closeable to, in combination, close an opening of the recycling sack wherein, in a closed position of the first and one or more additional flaps, the toggle extends through each of the one or more flap apertures.

### CROSS-REFERENCE TO RELATED PATENT APPLICATIONS

This application is claims priority to U.S. Provisional Application No. 62/236,510 filed on Oct. 2, 2015, the content of each application is hereby incorporated by reference in its entirety.

### FIELD OF INVENTION

The disclosure relates generally to waste management and more particularly to storage of recyclables.

### BACKGROUND

Recyclables generated by commercial facilities are typically high volume and must be sorted and then stored on-site until a management service can remove them. Conventionally, businesses use dumpsters to store recyclables, but dumpsters are large, relatively expensive, and not easily scalable on an on-demand basis to suit need.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a side view of a recycling sack in an expanded state in accordance with various embodiments.

FIG. 1B is a top view of a frame of a recycling sack in a collapsed state in accordance with various embodiments.

FIG. 1C is a partial cross-sectional side view of a recycling sack in an expanded state in accordance with various embodiments.

FIG. 2A is a top view of a recycling sack closure in a closed position in accordance with various embodiments.

FIG. 2B is a detail view of a first flap of a recycling sack closure in accordance with various embodiments.

FIG. 2C is a detail view of a second flap of a recycling sack closure in accordance with various embodiments.

### DETAILED DESCRIPTION

As explained above recyclables generated by commercial facilities are typically high volume and must be sorted and then stored on-site until a management service can remove them. Conventionally, businesses use dumpsters to store recyclables, but dumpsters are large, relatively expensive, and not easily scalable on an on-demand basis to suit need. Some businesses have attempted to store recyclables in large shipping bags. However, shipping bags are not designed for or capable of easy on-site transport or for enduring prolonged outdoor exposure while resting on pallets or the ground. Furthermore, shipping bags are either sealed for transporting liquids or fine aggregates such as sand or they are configured as open-topped bins. Sealed/sealable shipping bags can be expensive, difficult to load, difficult to load, and incapable of receiving large objects (e.g., bales of cardboard). Open-topped bin shipping bags are unsuited for outdoor use because they allow wildlife or other animals to easily enter the bag and are susceptible to filling with precipitation, resulting in increased weight of the contents of the shipping bag, attraction of insects, breeding of disease, and the production of offensive odors.

Methods and apparatus are provided herein for an express recycling sack for storing recyclables. The recycling sack, in accordance with various embodiments, includes a frame including a base and at least one collapsible element, the frame configurable in a collapsed state and an expanded state. The recycling sack can also include a flexible body attached to the frame, wherein, in the expanded state of the frame, the frame and the flexible body define an interior volume of the recycling sack and an opening of the recycling sack, the opening positioned opposite the base of the frame. The recycling sack also includes a plurality of open drain apertures defined in the flexible body proximate the base of the frame for maintaining drainage of fluid within the recycling sack. The recycling sack also includes a plurality of straps affixed to the flexible body proximate the base of the frame. The recycling sack also includes a first flap extending from the flexible body proximate the opening of the recycling sack. The recycling sack also includes a toggle retained in and protruding perpendicularly from the first flap. The recycling sack also includes one or more additional flaps extending from the flexible body proximate the opening of the recycling sack. The recycling sack also includes one or more flap apertures defined in each of the one or more additional flaps, wherein the first flap and the one or more additional flaps are closeable to, in combination, close the opening of the recycling sack and wherein, in a closed position of the first flap and the one or more additional flaps, the toggle extends through each of the one or more flap apertures.

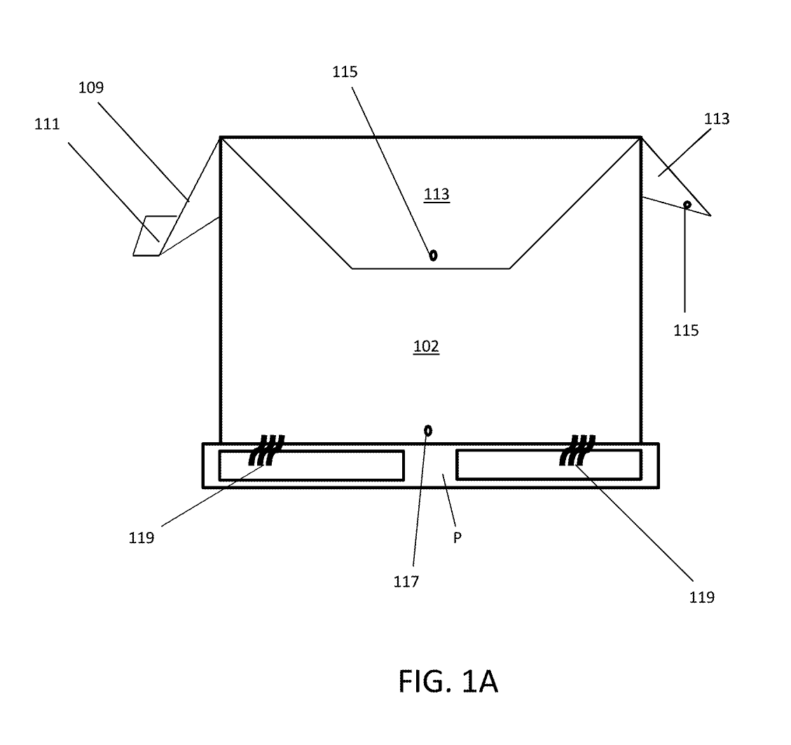

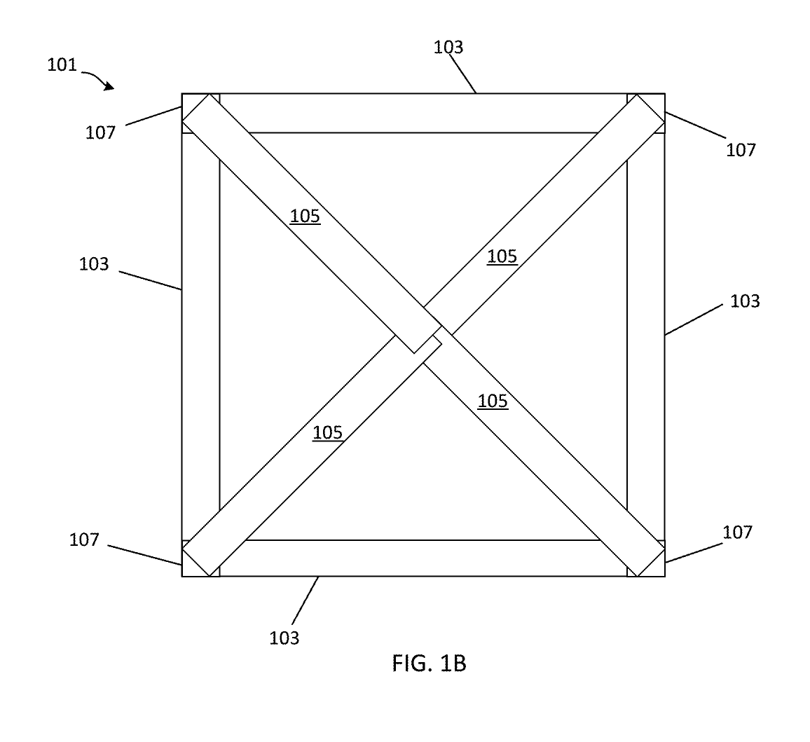

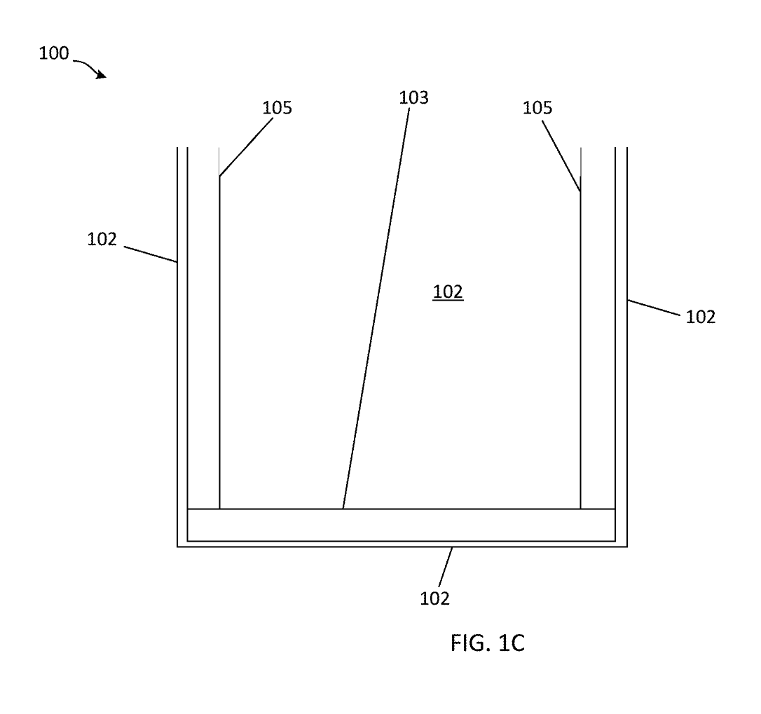

Referring now to FIGS. 1A-1C, a recycling sack 100, in accordance with various embodiments, includes a frame 101 having a base 103 and at least one collapsible element 105 for reconfiguration of the frame 101 between a collapsed state (e.g., as shown in FIG. 1B) and an expanded state (e.g., as shown in FIGS. 1A and 1C). A flexible body 102, in accordance with various embodiments, can be attached to the frame 101 such that, in the expanded state of the frame 101, the frame 101 and the flexible body 102 define an interior volume of the recycling sack 100 and an opening 121 of the recycling sack 100. A closure 108 of the recycling sack 100 includes a plurality of flaps 109, 113 protruding from the flexible body 102 proximate the opening 121. The closure 108, in accordance with various embodiments includes a first flap 109 having a toggle 111 retained in and protruding from the first flap 109 and one or more additional flaps 113 each having a flap aperture 115 defined therein. In use, the flaps 109, 113 are closeable so that the toggle 111 of the first flap 109 extends through the flap apertures 115 of the one or more additional flaps 113, thereby closing the opening 121 of the recycling sack 100. Drainage of fluid from within the recycling sack 100 can be maintained, in accordance with various embodiments, by the inclusion of a plurality of open drain apertures 117 defined in the flexible body 102. The recycling sack 100, in accordance with various embodiments, includes a plurality of straps 119 affixed to the flexible body 102 proximate the base 103 of the frame 101.

Frame 101, in accordance with various embodiments, can be constructed, for example, of wood, wire, spring wire, spring steel, metal, a plastic, a polymer, a composite material, any rigid material, any semi-rigid material, any resilient material, or combinations thereof. Referring now to FIG. 1B, which, for clarity, shows the frame 101 without the flexible body, the frame 101, in accordance with various embodiments, can include a rigid base 103 having a square or rectangular cross-section and defining an interior space. As shown in FIG. 1B, the collapsible element(s) 105, in accordance with various embodiments, can be rigid elongated members hingedly engaged with each corner of the base 103 by hinges 107 for reconfiguration between the collapsed state and the expanded state. However, it will be apparent in view of this disclosure that numerous alternative frame 101 configurations are contemplated herein. For example, the base 103 can be configured in any cross-sectional shape (e.g., square, rectangle, parallelogram, circle, triangle, pentagon, hexagon, or any other shape), can be made of any one or more of rigid, semi-rigid, plastic, or resilient materials as described above, and can be a solid sheet, outline a perimeter of the recycling sack 100, or can be any other suitable configuration (e.g., a honeycomb, a sheet having apertures defined therein, a perimeter outline having a plurality of support members disposed therein). Similarly, the collapsible members 105 can be configured from any suitable element type (e.g., collapsible or foldable poles, foldable legs, extendable legs or poles, accordion fence elements, spring wire, or any other collapsible or foldable structures), can be configured to create any suitable expanded shape of the frame 101 (e.g., cylinder, cube, rectangular prism, triangular prism, barrel shape, or any other suitable shape), and can be made of any one or more of rigid, semi-rigid, plastic, or resilient materials as described above. Similarly, the overall frame 101, in accordance with various embodiments, can be expandable and collapsible by any suitable configuration or mechanism, including, for example, folding/unfolding of hinged elements, releasing of retained spring elements, pop-up elements (e.g., similar to a pop-up tent), unfolding and assembling of foldable pole elements, expansion of accordion elements, or any other suitable mechanism.

Flexible body 102, in accordance with various embodiments, can be constructed, for example, of a woven textile, a non-woven textile, a waterproof textile, a water-resistant textile, a fabric, leather, a plastic, a polymer, any other suitable flexible material, or combinations thereof. In accordance with various embodiments, the flexible body 102 can, for example, be attached to the frame by an adhesive, extension of one or more collapsible members 105 through or into one or more sleeves or pockets (not shown) formed on the flexible body 102, stitching one or more portions of the flexible body 102 over at least a portion of the frame 101 to retain the at least a portion of the frame 101 within the flexible body 102, or any other suitable method. The flexible body 102, in accordance with various embodiments, can be retained within the frame 101, can, as shown in FIG. 1C, be attached externally of the frame 101, or can enclose all or a portion of the frame 101 therein.

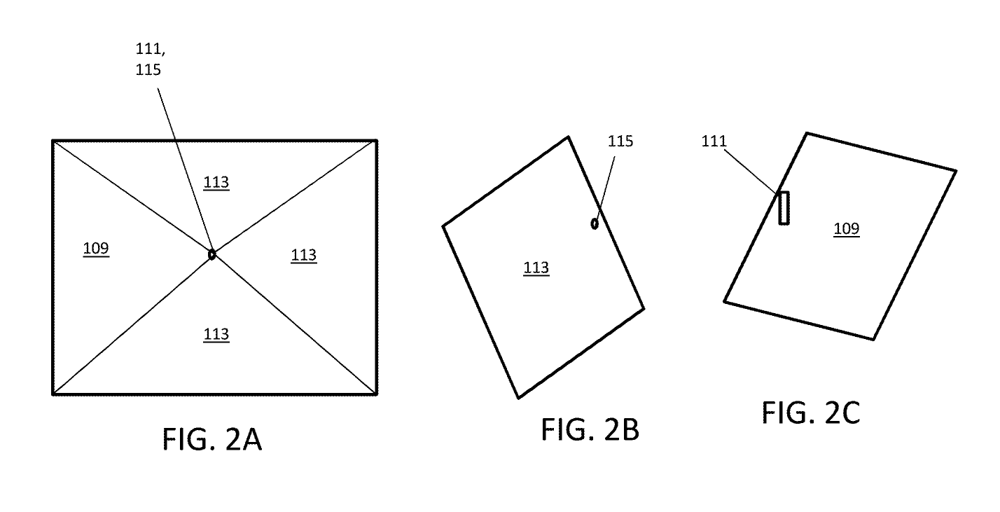

Referring now to FIGS. 1A, 2A, 2B, and 2C, flaps 109, 113 can be rigid, semi-rigid, resilient, plastic, or flexible and can be constructed of any suitable material or materials including, for example but not limited to, any of the materials described herein with reference to the frame 101 and the flexible body 102. As shown in FIGS. 1A, 2A, 2B, and 2C, the flaps 109, 113 are flexible elements integral with and extending from the flexible body 102. However, it will be apparent in view of this disclosure that the flaps 109, 113 can, in accordance with various embodiments, be separate elements which are stitched, adhered, or otherwise attached to the flexible body 102 and or the frame 101. It will further be apparent in view of this disclosure that each of the flaps 109, 113 can be constructed as a single element structure (e.g., constructed from the same material as the flexible body 102 as shown or of the same material as the frame 101) or can be a two element structure (e.g. having a flap frame and a flap flexible body similar to the construction of the frame 101 and flexible body 102 of the recycling sack 100).

The flaps 109, 113 collectively form a closure 108 of the recycling sack 100. In accordance with various embodiments, the first flap 109 includes a toggle 111 retained in and protruding from therefrom. The toggle 111, in accordance with various embodiments can be any suitable size and shape for extending through the flap apertures 115 defined in each of the one or more additional flaps 113 during closure. For example, the toggle 111 can be an elongated rod, a hook, an elongated structure defining an eyelet, a two-part structure having a fixed narrow portion extending from the first flap 109 and a rotable wide portion extending from the fixed narrow portion, or any other suitable configuration. In accordance with various embodiments, the flap apertures 115 can be defined as simple holes defined in a corresponding additional flap 113, can be defined by one or more grommets (not shown) retained in the corresponding additional flap 113, or can be defined in any other suitable manner. The flap apertures 115 can be any suitable shape and size for receiving the toggle 111 therethrough. For example, in accordance with various embodiments, the flap apertures 115 can be round, elongated (e.g., forming a slot), rectangular, octagonal, or any other suitable shape for receiving a toggle 111. In accordance with various embodiments, the flap apertures 115 are sized and shaped to receive a toggle 111 formed as an elongated body having an eyelet (e.g., as shown in FIG. 1A) defined therein. In such embodiments, the recycling sack 100 can also include a locking strap (not shown) for being received through the eyelet of the toggle 111 after the toggle 111 is received through the flap apertures 115 of the additional flaps 113. In accordance with various embodiments, a first end of the locking strap can be receivable through the eyelet of the toggle and a second end of the locking strap can be affixed to the frame 101 or the flexible body 102 so that, upon tying or securing of the locking strap, the closure 108 is retained in a closed position, wherein the opening 121 of the recycling sack 100 is closed. Advantageously, closure 108 can, in accordance with various embodiments, prevent ingress of wild or other animal life into the recycling sack 100 once the recycling sack is filled and stored outdoors. Furthermore, in accordance with various embodiments, the closure provides a precipitation barrier to reduce or prevent accumulation of precipitation within the recycling sack 100.

Open drain apertures 117, in accordance with various embodiments, can be defined as simple holes defined in the flexible body 102, can be defined by one or more grommets (not shown) retained in the flexible body 102, can be defined by open tubing retained in the flexible body, or can be defined in any other suitable manner for maintaining drainage of fluid from within the recycling sack 100. In order to maintain the drainage of fluid from within the recycling sack 100, at least a portion of a passageway or opening through each of the drain apertures 117 is maintained during use of the recycling sack 100. In accordance with various embodiments, in order to maximize drainage, the open drain apertures 117 are preferably positioned proximate the base 103 of the frame 101. However, it will be apparent in view of this disclosure that, in accordance with various embodiments, open drain apertures 117 can be positioned anywhere on flexible body 102. Open drain apertures 117 advantageously allow drainage of precipitation, water, and other fluids from the interior of the recycling sack 100, thereby preventing increased weight, offensive odors, and other undesirable side-effects of moisture accumulation within the recycling sack 100.

Straps 119, in accordance with various embodiments, can be constructed, for example but not limited to, of any of the materials described above with reference to flexible body 102 or frame 101. The straps 119 can be any suitable configuration including, for example, ratchet straps, compression straps, tie straps (e.g., configured in one or more pairs and positioned for each strap of each pair to be tied together as shown in FIG. 1A). In use, as shown in FIG. 1A, the straps can be configured and sized to be secured to one or more pallets P. In accordance with various embodiments the straps 119 are adjustable for attachment to any one or more of a wooden pallet, a plastic pallet, a steel pallet, an ISO pallet, a North American pallet, a GMA pallet, a European pallet, an Australian Standard pallet, a MIL-STD-1660 pallet, a stringer pallet, a block pallet, or a perimeter base pallet. Attachment of the recycling sack 100 to a pallet P can, in accordance with various embodiments, advantageously permit easy on-site transport of recycling sacks by, for example, a forklift. Further advantageously, attachment of the recycling sack 100 to a pallet P, in accordance with various embodiments, promotes drainage by providing a raised resting surface during outdoor storage, allowing fluid space beneath the recycling sack 100 to flow outward from the open drain apertures 117.

In use, in accordance with various embodiments, a recycling sack 100 in a collapsed state of the frame 101 can be attached to a pallet P by the straps 119. Then a user can expand the collapsible elements 105 to reconfigure the frame 101 into an expanded state, with the closure 108 open so as to receive recyclables into the recycling sack 100. The user can then load the recycling sack 100 with recyclables or other material through the opening 121. Upon at least partially filling the recycling sack 100, the user can reposition the flaps 109, 113 so that the toggle 111 of the first flap 109 extends through the flap apertures 115 of the additional flaps 113, thereby closing the closure 108 and the opening 121 of the recycling sack 100. The user can then transport (e.g., using a forklift to raise the pallet P) the recycling sack 100 to a storage location. Due to the closed position of the closure 108, the recycling sack 100 then prevents ingress of wildlife or other animals as well as reducing the ingress of precipitation. Furthermore, the open drain apertures 117 maintain drainage of any fluid from an interior of the recycling sack 100. Thus the recyclables can be stored in a secure and sanitary manner until recovery by a waste management service.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A recycling sack comprising:
a frame including a base and at least one collapsible element, the frame configurable in a collapsed state and an expanded state;
a flexible body attached to the frame, wherein, in the expanded state of the frame, the frame and the flexible body define an interior volume of the recycling sack and an opening of the recycling sack, the opening positioned opposite the base of the frame;
a plurality of open drain apertures defined in the flexible body proximate the base of the frame for maintaining drainage of fluid within the recycling sack;
a plurality of straps affixed to the flexible body proximate the base of the frame;
a first flap extending from the flexible body proximate the opening of the recycling sack;
a toggle retained in and protruding perpendicularly from the first flap;
one or more additional flaps extending from the flexible body proximate the opening of the recycling sack; and
one or more flap apertures defined in each of the one or more additional flaps,
wherein the first flap and the one or more additional flaps are closeable to, in combination, close the opening of the recycling sack,
wherein, in a closed position of the first flap and the one or more additional flaps, the toggle extends through each of the one or more flap apertures.

2. The recycling sack of claim 1, wherein the plurality of straps are configured in one or more pairs and positioned for each strap of each pair to be tied together.

3. The recycling sack of claim 2, wherein each pair of straps is sized to be tied to at least one of a wooden pallet, a plastic pallet, a steel pallet, an ISO pallet, a North American pallet, a GMA pallet, a European pallet, an Australian Standard pallet, a MIL-STD-1660 pallet, a stringer pallet, a block pallet, or a perimeter base pallet.

4. The recycling sack of claim 1, wherein the frame is constructed of at least one of wood, wire, metal, a plastic, a polymer, or a composite material.

5. The recycling sack of claim 1, wherein the flexible body is constructed of at least one of a woven textile, a non-woven textile, a waterproof textile, a water-resistant textile, a fabric, leather, a plastic, or a polymer.

6. The recycling sack of claim 1, further comprising a locking strap, a first end of the locking strap receivable through an eyelet defined within the toggle for securing the first flap and the one or more additional flaps in the closed position.

7. The recycling sack of claim 6, wherein a second end of the locking strap is affixed to the flexible body.

8. The recycling sack of claim 1, wherein the one or more flap apertures is defined by one or more grommets retained in each of the one or more additional flaps and wherein, in a closed position of the first flap and the one or more additional flaps, the toggle extends through each of the one or more grommets.

9. The recycling sack of claim 1, wherein the plurality of open drain apertures are defined by one or more grommets retained in the flexible body proximate the base of the frame.
